(19) United States
(12) Patent Application Publication
(10) Pub. No.: US 2011/0235619 A1
(43) Pub. Date: Sep. 29, 2011

(54) ENHANCED FREQUENCY DIVERSITY TECHNIQUE FOR SYSTEMS WITH CARRIER AGGREGATION

(75) Inventors: Chia-Chin Chong, Santa Clara, CA (US); Hlaing Minn, Allen, TX (US)

(73) Assignee: NTT DOCOMO Inc., Tokyo (JP)

(21) Appl. No.: 13/073,707

(22) Filed: Mar. 28, 2011

Related U.S. Application Data
(60) Provisional application No. 61/318,696, filed on Mar. 29, 2010.

(51) Int. Cl. H04B 7/216; H04L 27/00; H04J 13/00

(52) U.S. Cl. 370/335; 375/259; 370/479

(57) ABSTRACT

A technique is provided to interleave data and control signals across a plurality of component carriers to achieve frequency diversity in conjunction with carrier aggregation.

### RELATED APPLICATION

This application claims the benefit of U.S. Provisional Application No. 61/318,696, filed Mar. 29, 2010.

### TECHNICAL FIELD OF THE INVENTION

This application relates to wireless communication, and more to particularly to the implementation of carrier aggregation in wireless communication.

### BACKGROUND

The famous Shannon's law for communication establishes a linear proportionality between available channel bandwidth and the amount of data that can be transmitted through the corresponding channel. As determined by this law, higher data rates require more bandwidth at a given signal-to-noise ratio (SNR) as opposed to lower data rate communications at the same SNR. But a given amount of bandwidth has a relative amount of worth: signal attenuation is markedly higher as frequency increases. Thus, it is better to have bandwidth in the regulated spectrums such as at 700 MHz as opposed to having the same amount of bandwidth in the unregulated higher frequency bands such as at 2.4 GHz.

Despite the scarceness of desirable spectrums for wireless communications, the requirement for additional bandwidth is ever increasing. Indeed, regardless of the particular frequency for wireless communication, the need for bandwidth is non-negotiable if one wants to achieve higher data rates. Modern 4G telecommunication protocols such as Long Term Evolution-Advanced (LTE-A) are proposing 1 Gps (one billion bits per second) downlink data rates or even higher. But it is difficult to achieve such a data rate in the limited communication bandwidths that are available to a wireless carrier, particularly in the desirable “beachfront” spectrums such as 700 MHz. For example, the current generation of LTE uses orthogonal subcarriers spread across a channel bandwidth that may range from 1.4 MHz to a maximum of 20 MHz. The subcarriers are separated by 15 KHz such that the maximum symbol rate for each subcarrier is thus 15,000 symbols/second. The number of bits per symbol depends upon the modulation scheme—LTE supports a maximum of 64 bits per symbol using 64QAM. Thus, the 20 MHz channel of LTE supports a raw data rate of 108 Mbps. The actual data rate will depend upon coding overhead and other variables. One can thus appreciate that if LTE-A is to achieve a 1 Gps data rate, the channel bandwidth must be increased by multiples of the LTE 20 MHz channel But note that backward compatibility with conventional LTE should be maintained. Thus, carrier aggregation in LTE-A involves the use of multiple 20 MHz channels. To a conventional LTE handset (which may be designated as user equipment (UE)), each 20 MHz channel operates as a conventional LTE channel. But to an LTE-A UE, data can be received across multiple combinations of such channels. Since each LTE channel corresponds to an LTE carrier, the LTE carrier becomes a component carrier for an LTE-A UE. Carrier aggregation thus preserves precious bandwidth resources for conventional lower-data-rate communication yet achieves greater bandwidth resources for high-data-rate communication.

One of the main technical challenges for implementing carrier aggregation in LTE-Advanced systems is the backward compatibility requirement with the current LTE systems. The additional bandwidth provided by carrier aggregation provides an opportunity for frequency diversity. But because of the complications raised by the need for backwards compatibility, existing carrier aggregation schemes do not exploit frequency diversity. Instead, conventional carrier aggregations schemes enjoy frequency diversity only within each component carrier—for example, a conventional uplink LTE channel is interleaved. Accordingly, there is a need in the art for improved carrier aggregation schemes that exploit the opportunity for frequency diversity across the component carriers rather than just within each component carrier.

### SUMMARY

In accordance with an aspect of the disclosure, a method is provided that includes the acts of providing a plurality of transport blocks, each transport block corresponding to a component carrier (CC); in a baseband processor, channel coding each transport block into a corresponding channel-coded data signal; in the baseband processor, bit-combining the channel-coded data signals into a bit-combined data signal; and in the baseband processor, interleaving the bit-combined data signal to produce an interleaved plurality of code words.

In accordance with another aspect of the disclosure, a downlink method is provided that includes the acts of determining whether a plurality of component carriers are being interleaved; if a plurality of component carriers are being interleaved, bit-combining a plurality of channel-coded data signals to form a bit-combined data signal; writing the bit-combined data signal into an interleaver matrix stored within a memory, wherein the interleaver matrix is arranged into a plurality of sub-matrices corresponding to the plurality of component carriers; reading from each sub-matrix to retrieve a corresponding output data signal; and modulating each component carrier according to the corresponding output data signal.

In accordance with yet another aspect of the disclosure, a wireless device, is provided that includes a memory; a baseband processor configured to channel code a plurality of transport blocks into a corresponding plurality of channel-coded data signals, bit-combine the channel-coded data signals into a bit-combined data signal, write the bit-combined data signal into an interleaver matrix stored within the memory, and to read from the interleaver matrix to produce an interleaved data signal; and a radio-frequency integrated circuit (RFIC) configured to modulate an RF carrier signal according to the interleaved data signal.

### BRIEF DESCRIPTION OF THE DRAWINGS

FIG. 1 illustrates the transport block processing modules for an LTE uplink shared channel.

FIG. 2 is a flowchart for the interleaver operation performed with regard to FIG. 1.

FIG. 3 illustrates the transport block processing modules for an LTE downlink shared channel.

FIG. 4 illustrates the transport block processing modules and channel interleaver for uplink shared channel with carrier aggregation.

FIG. 5 is a flowchart for the interleaver operation performed with regard to FIG. 4.

FIG. 6 illustrates the transport block processing modules and channel interleaver for a downlink shared channel with carrier aggregation.

FIG. 7 is a flowchart for the interleaver operation performed with regard to FIG. 6.

FIG. 8 is a block diagram of a wireless device configured to achieve frequency diversity through carrier aggregation in accordance with either the downlink or uplink embodiments of FIGS. 1-7.

### DETAILED DESCRIPTION

Frequency diversity carrier aggregation is described herein with regard to a Long Term Evolution Advanced (LTE-A) implementation. However, it will be appreciated that the principles of the disclosed carrier aggregation are readily applicable to other wireless communication protocols such as WiMax. The carrier aggregation of the present application is denoted as frequency diversity carrier aggregation in that frequency diversity across the aggregated component carriers is advantageously achieved yet backwards compatibility with conventional LTE (no carrier aggregation) is maintained. This compatibility is best understood with regard to the shared channel, which is used to transmit both data and some control information.

The shared channel data and control information passes from the MAC layer in LTE systems to the physical (PHY) layer through transport channels, which form the interface between the MAC and PHY layers. The uplink and downlink transport channels process data in transport blocks, which are groups of resource blocks sharing a common modulation and coding implementation. In addition to a shared transport channel in both the uplink and downlink, there are other types of transport channels such as a broadcast channel and a random access channel. But since the focus of carrier aggregation is to increase data rate, only the data-carrying shared channels are discussed herein. To illustrate the difficulties of maintaining backward compatibility, the LTE conventional processing of the downlink and uplink shared channels will be discussed and contrasted with the carrier aggregation processing for these channels. The uplink shared transport channel will be discussed first followed by the downlink shared transport channel

### Uplink Transport Channel Processing in LTE

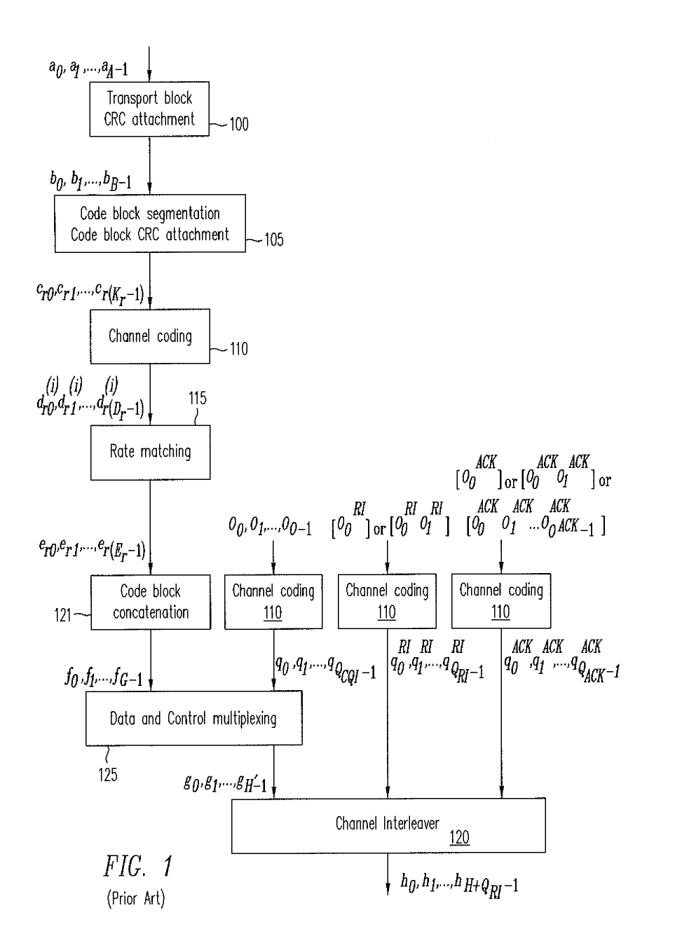

Turning now to the drawings, the transport channel processing for a conventional LTE uplink shared channel (UL-SCH) is illustrated in FIG. 1. This transport channel processing occurs as set forth in 3GPP TS 36.212 Multiplexing and Channel Coding (Release 9), which will hereinafter be referred to simply as “LTE Release 9” and is incorporated herein in its entirety. Data arrives at a CRC attachment coding unit 100 in the as a maximum of one MAC protocol data unit (PDU) every transmission time interval (TTI). The data portion of a MAC PDU may be represented by a vector a₀, a₁, a₂ a₃, . . . a_{A-1} that is A bits long. Coding unit 100 calculates a corresponding number L of parity bits p₀, p₁, p₂, p₃, . . . , p_{L-1}, where L is determined by the particular CRC length. In LTE, L can be either sixteen or twenty-four bits. The bits produced by CRC attachment coding unit 100 are represented by a vector b₀, b₁, b₂, b₃, . . . , b_{B-1} of length B, where B equals A plus L. The length B for this vector may be too long for a subsequent channel coding step that may accommodate only Z bits. This if Z is less than B, the output from coding unit 100 is processed into shorter blocks with an additional CRC attachment in code block segmentation and CRC attachment module 105. The output from module 105 may be represented by a vector cᵣ_{⁰}, cᵣ_{¹}, cᵣ_{²}, cᵣ_{³}, . . . , c_{r(E}_{ᵣ}₋₁₎ of length Kᵣ. A channel coding module 110 receives the output from module 105 and applies the appropriate turbo coding to produce multiple output signals ranging from an i=0 to an i=1 channel-coded signal, where the 1^{th} channel-coded signal may be represented by a vector dᵣ_{⁰}⁽ⁱ⁾, dᵣ_{¹}⁽ⁱ⁾, dᵣ_{²}⁽ⁱ⁾dᵣ_{³}⁽ⁱ⁾, . . . , d_{r(D}_{^{r}}₋₁₎⁽ⁱ⁾ of length Dᵣ=Kᵣ+1. A rate matching module 115 interleaves the channel-coded signals from the channel coder and performs bit selection and pruning to produce an output signal represented by a vector eᵣ_{⁰}, eᵣ_{¹}, eᵣ_{²}, eᵣ_{³}, . . . , e_{r(E}_{^{r}}₋₁₎ of length Eᵣ for code block r. A code block concentration module 121 concatenates the rate matching outputs for the different code blocks to produce an output signal represented by a vector f₀, f₁, f₂, f₃, . . . , f_{G-1} of length G.

The control data for the transport block arrives at channel coding module 110 in three forms: channel quality information (CQI), rank indication (RI), and hybrid automatic repeat request acknowledgment (HARQ-ACK). The corresponding channel coded signals are represented by vectors q₀^{ACK}, q₁^{ACK}, . . . , q_{Q′}_{_{ACK}}₋₁^{ACK} for the coded HARQ-ACK data [q′₀^{RI}, q′₁^{RI}q′₂^{RI}, . . . , q′_{NG′}^{^{RI}}₋₁^{RI}] for the coded RI data, and q₀^{RI}, q₁^{RI}, q₂^{RI}, . . . , q_{Q′}_{_{RI}}₋^{RI} for the coded CQI/PMI data. For frequency diversity exploitation of carrier aggregation, interleaved coded modulation may be used to capture the frequency diversity. Consequently, channel coding module 110 and rate matching module 115 (which includes an internal sub-block interleaver for the received data signals) are most relevant to frequency diversity exploitation. Since there is also control information as discussed above that is transmitted in the uplink shared channel, a channel interleaver 120 across the data and control information is applied in the uplink shared channel. This is a simple symbol interleaver where modulation symbols are written to a rectangular matrix row-by-row and read out column-by-column.

Prior to interleaving, the CQI encoded sequence (represented by the vector q₀^{RI}, q₁^{RI}, q₂^{RI}, . . . q_{Q′}_{_{RI}}₋₁^{RI}) is multiplexed with the uplink shared data (represented by vector eᵣ_{⁰}, eᵣ_{¹}, eᵣ_{²}, . . . , e_{r(E}_{^{r}}₋₁₎) in a data and control multiplexer 125 to produce a multiplexed output signal represented by g₀, g₁, g₂, . . . , g_{H′-1}, where H′=H/Qₘ and H=(G+Q_{cQt}), and where gᵢ, i=0, . . . , H′−1 are column vectors of length Qₘ corresponding to the modulation order. In this fashion, data and control information are mapped to different modulation symbols. H is the total number of coded bits allocated for UL-SCH data and CQI/PMI information. As further discussed in LTE Release 9, the control information and the data shall be multiplexed in multiplexer 125 according to the following pseudocode:

```
Set i,j, k to 0
while j < Q_{CQI} -- first place the control information
        gₖ = [qⱼ ...q_{j+Qm}⁻¹]^{T}
        j = j + Qₘ
        k = k + 1
end while
while i < G -- then place the data
        gₖ = [fᵢ ... f_{i+Qm}⁻¹]^{T}
        i = i + Qₘ
        k = k + 1
end while
```

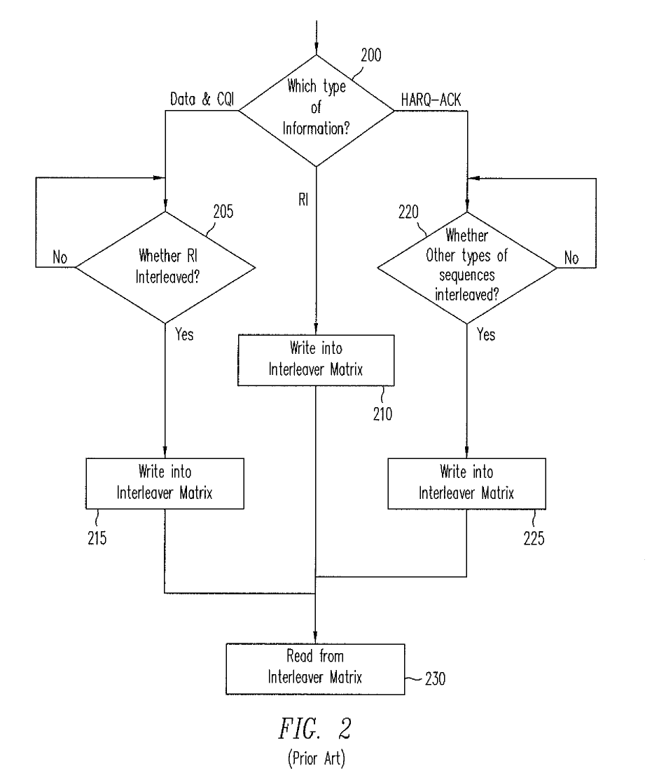

Channel interleaver 120 interleaves such that HARQ-ACK indications are present on both slots in a subframe. The number of modulation symbols in each subframe is given by H″=H′+Q′_{RI}. As defined by LTE Release 9, an output bit sequence from interleaver 120 represented by h₀, h₁, h₂, . . . , h_{H+Q}_{_{RI}}₋₁. To produce this interleaved output, interleaver 120 may be considered to construct a matrix of output signals that are written row-by-row into a memory or buffer but read out from memory column-by-column. The number of columns for this output matrix from interleaver 120 is Cₘᵤₓ=N_{symb}^{PUSCH}. The column s of the matrix are numbered 0,1,2,K,Cₘᵤₓ−1 from left to right, and N_{symb}^{PUSCH} is determined as discussed in section 5.2.2.6 of LTE Release 9. The number of rows of the interleaver output matrix is Rₘᵤₓ=(H″·Qₘ)/Cₘᵤₓ, and LTE Release 9 defines R′ₘᵤₓ=Rₘᵤₓ/Qₘ. The rows of the interleaver output matrix are thus numbered 0,1,2, K, Rₘᵤₓ−1 from top to bottom. The interleaving process performed by interleaver 120 is illustrated in FIG. 2. An initial step 200 determines what type of information is being currently interleaved—in other words, whether the information being interleaved is the multiplexed data and CQI, rank indication (RI), or HARQ-ACK information. If RI information is transmitted in the current subframe, interleaver 120 will first process the RI information prior to processing the multiplexed data and CQI. Thus, if step 200 indicates that data and CQI is currently being processed, a step 205 determines whether the RI information (if present) has been already interleaved into the output matrix. If step 200 indicates that RI information is being processed, the RI information is written into the output matrix in a step 210 as follows. The vector sequence q₀^{RI}, q₁^{RI}, q₂^{RI}, . . . , q_{Q′}_{_{RI}}₋₁^{RI} is written into the columns as indicated by Table I below, and by sets of Qₘ rows starting from the last row and moving upwards according to the following pseudo code:

Set i,j to 0.
Set r to R′ₘᵤₓ −1
while i < Q′_{RI}

c_{RI} = Column Set(j)
y_{r×C}_{ₘᵤₓ}₊_{c}_{_{R1}} = qᵢ^{RI}
i = i + 1
r = R′ₘᵤₓ −1−└i/4┘
j = (j + 3)mod 4

end while

The variable Column Set is given in Table 1 and indexed left to right from 0 to 3.

Having thus written the RI data to the output matrix (if there is such data to be written), interleaver 120 may then process the multiplexed data and CQI information in a step 215 as follows: interleaver 120 writes the input vector sequence, for k=0, 1, . . . H′−1, into the (Rₘᵤₓ×Cₘᵤₓ) matrix by sets of Qₘ rows starting with the vector y₀ in column 0 and row 0 to (Qₘᵤₓ−1) and skipping the matrix entries that are already occupied:

$$[ \begin{matrix}{\underline{y}}_{0} & {\underline{y}}_{1} & {\underline{y}}_{2} & … & {\underline{y}}_{{C}_{mux} - 1} \\ {\underline{y}}_{{C}_{mux}} & {\underline{y}}_{{C}_{mux} + 1} & {\underline{y}}_{{C}_{mux} + 2} & … & {\underline{y}}_{2 {C}_{mux} - 1} \\ ⋮ & ⋮ & ⋮ & ⋱ & ⋮ \\ {\underline{y}}_{( {R}_{mux}^{′} - 1 ) \times {C}_{mux}} & {\underline{y}}_{( {R}_{mux}^{′} - 1 ) \times {C}_{mux} + 1} & {\underline{y}}_{( {R}_{mux}^{′} - 1 ) \times {C}_{mux} + 2} & … & {\underline{y}}_{( {R}_{mux}^{′} \times {C}_{mux} - 1 )}\end{matrix} ]$$

The pseudocode is as follows:

```
Set i, k to 0.
  while k < H′,
  if yᵢ is not assigned to RI symbols
  yᵢ = gₖ
  k = k + 1
  end if
  i = i+1
  end while
```

The HARQ-ACK information (if present) is written last to the output matrix by interleaver 120. Thus, if HARQ-ACK information is to be transmitted in the current subframe, a step 220 tests for whether the RI information and the multiplexed data and CQI information has been already interleaved. Only after all the other types of input sequences have been interleaved does interleaver 120 finally interleave the HARQ-ACK information in a step 225 as follows: the vector sequence q₀^{ACK}, q₁^{ACK}, q₂^{ACK}, . . . , q_{Q′}_{_{ACK}}₋₁^{ACK} is written into the columns as indicated by Table 2 below and by sets of Qₘ, rows starting from the last row and moving upwards according to the following pseudocode. Note that this operation overwrites some of the channel interleaver entries obtained from the previous pseudocode discussion.

Set i,j to 0.
Set r to R′ₘᵤₓ −1
while i < Q′_{ACK}

c_{ACK} = ColumnSet(j)
y_{r×C}_{ₘᵤₓ}_{+c}_{_{ACK}} = qᵢ^{ACK}
i = i + 1
r = R′ₘᵤₓ −1−└i/4┘
j = (j + 3)mod 4

end while

The Column Set is given in Table 2 and indexed left to right from 0 to 3. The output of interleaver 120 is the bit sequence read out column-by-column from the (Rₘᵤₓ×Cₘᵤₓ) matrix constructed as just discussed. The bits after channel interleaving are denoted by h₀, h₁, h₂, . . . , h+Q_{_{RI}}₋₁.

TABLE 1
Column set for Insertion of rank information.

| CP configuration | Column Set |
|---|---|
| Normal | {1, 4, 7, 10} |
| Extended | {0, 3, 5, 8} |

TABLE 2
Column set for Insertion of HARQ-ACK information.

| CP configuration | Column Set |
|---|---|
| Normal | {2, 3, 8, 9} |
| Extended | {1, 2, 6, 7} |

Having thus constructed the output matrix, which can be stored in memory as discussed above, interleaver 120 may then read out the output matrix column-by-column in a step 230 to finish the interleaving process. The end result of this processing of a transport block is typically denoted as an LTE codeword. The conventional LTE downlink shared channel will now be discussed.

### Downlink Transport Channel Processing in LTE

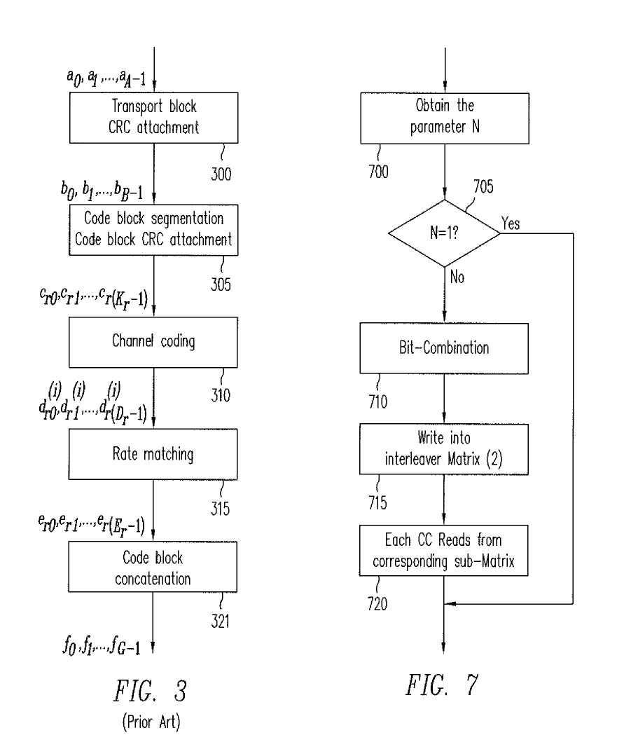

The transport channel processing for a conventional LTE downlink shared channel (DL-SCH) is shown in FIG. 3. For the downlink, the paging channel (PCH) and multicast channel (MCH) have the same processing with DL-SCH. The procedures of DL-SCH are quite similar to the UL-SCH. This transport channel processing occurs as set forth in LTE Release 9. Data arrives at a CRC attachment coding unit 300 as a maximum of one MAC protocol data unit (PDU) every transmission time interval (TTI). The MAC PDU may be represented by a vector a₀, a₁, a₂, a₃, . . . , a_{A-1} that is A bits long. Coding unit 100 calculates a corresponding number L of parity bits p₀, p₁, p₂, p₃, . . . , p_{L-1}, where L is determined by the particular CRC length. In LTE, L can be either sixteen or twenty-four bits. The bits produced by CRC attachment coding unit 300 are represented by a vector b₀, b₁, b₂, b₃, . . . , b_{B-1} of length B, where B equals A plus L. The length B for this vector may be too long for a subsequent channel coding step that may accommodate only Z bits. This if Z is less than B, the output from coding unit 300 is processed into shorter blocks with an additional CRC attachment in code block segmentation and CRC attachment module 305. The output from module 305 may be represented by a vector cᵣ_{⁰}, eᵣ_{¹}, eᵣ_{²}, eᵣ_{³}, . . . , e_{r(E}_{ᵣ}_{-1) of} length Kᵣ. A channel coding module 310 receives the output from module 305 and applies the appropriate turbo coding to produce multiple output streams ranging from an i=0 to an i=1 stream, where the i^{th} stream may be represented by a vector dᵣ_{¹}⁽ⁱ⁾, dᵣ_{¹}⁽ⁱ⁾, dᵣ_{²}⁽ⁱ⁾, . . . , d_{r(D}_{ᵣ}₋₁₎⁽ⁱ⁾ of length Dᵣ=Kᵣ+1. A rate matching module 315 interleaves the streams from the channel coder and perfoms bit selection and pruning to produce an output represented by a vector eᵣ_{⁰}, eᵣ_{¹}, eᵣ_{²}, eᵣ_{³}, . . . , e_{r(E}_{ᵣ}₋₁₎ of length Eᵣ for code block r. A code block concentration module 321 concatenates the rate matching outputs for the different code blocks to produce an output signal represented by a vector f₀, f₁, f₂, f₃, . . . , f_{G-1}, of length G. This output signal is the downlink LTE codeword. Thus, the only difference from the uplink shared channel processing is that no channel interleaver is used. Hence, only a set of internal interleavers inside rate matching module 315 help to capture the frequency diversity in a conventional LTE shared downlink channel.

However, all the mechanisms discussed above with regard to FIGS. 1-3 can only exploit the frequency diversity within one carrier component (CC). In an LTE-Advanced system, each CC fulfills a complete LTE feature set. More CCs will occupy more bandwidth. By interleaving across the whole bandwidth as discussed further herein will capture more frequency diversity than the conventional carrier aggregation approach in which each CC operates separately. A frequency diversity approach that is backwardly compatible with conventional LTE will now be discussed.

### Enhanced Frequency Diversity Exploitation in Carrier Aggregation

To exploit the enhanced frequency diversity opportunity presented by carrier aggregation (CA), an interleaver functioning across the different CCs is disclosed herein for CA systems. In this fashion, frequency diversity is exploited in carrier aggregation by interleaving bits across component cartiers. In general, backward compatibility with conventional LTE is a significant problem. However, backward compatibility is advantageously achieved by the disclosed frequency diversity technique as discussed further herein. In the downlink shared channel, the disclosed CA channel interleaver is added over the CCs, while for the uplink shared channel the proposed interleaver just takes place of the conventional LTE channel interleaver. The CA channel interleaver functions as a conventional LTE channel interleaver when there is only one CC. The CA channel interleaver exploits enhanced frequency and time diversity with the advantage of easy implementation.

### Uplink Carrier Aggregation Channel Interleaver

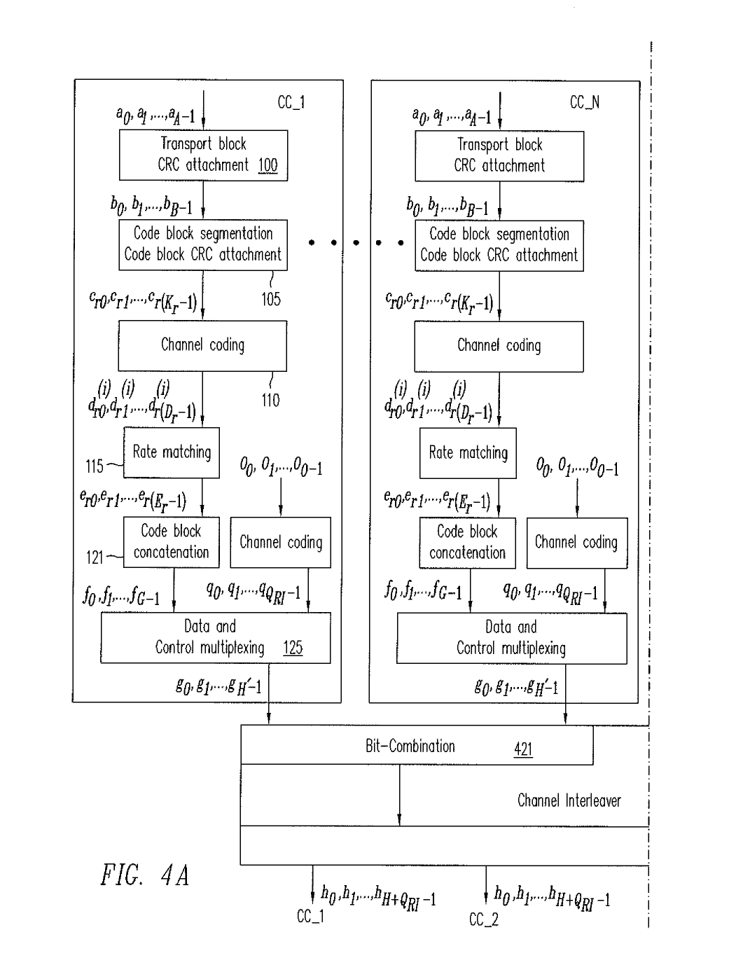

To better illustrate the disclosed CA channel interleaver, the following discussion assumes that there are N CCs, where N is some positive integer. As shown in FIG. 4, a CA channel interleaver 420 interleaves N multiplexed data and CQI information channel-coded portions of the N transport blocks, where each multiplexed data and CQI information channel-coded portion of the corresponding transport block is represented by a vector g₀, g₁, g₂, . . . , g_{H′-1}. Each transport block will have such a portion, ranging from a CC_{—}1 transport block to a CC_N transport block. Thus, it may be readily seen that modules 100, 105, 110, 115, and 110 for each transport block processing operate analogously as discussed above with regard to FIG. 1. Interleaver 420 thus interleaves N combined data and control information signals, each combined signal corresponding to the multiplexed data and control information, the RI information, and the HARQ-ACK information for a single CC transport block. To accommodate these N transport blocks, interleaver 420 includes two stages. A first bit combination stage occurs in modules 421, 422, and 423. Bit combination module 421 performs a bit combination on the N multiplexed data and CQI information signals. For example, suppose there are just 3 CCs being interleaved such that the multiplexed data and CQI information from a first one of the CCs may be designated as an input sequence [a₁, a₂, . . . , aₙ], the multiplexed data and CQI information from a second one of the CCs may be designated as an input sequence [b₁, b₂, . . . , bₙ], and the multiplexed data and CQI information from the remaining third CC may be designated an input sequence [c₁, c₂, . . . , cₙ]. Bit combiner 421 combines these example input signals to produce a bit-combined output signal [a₁, b₁, c₁, a₂, b₂, c₂ . . . , aₙ, bₙ, cₙ]. In general, the signals being bit combined may be thought of each being arranged from a zeroth word or vector (word 0) to a last word or vector (word H′−1). Each word has a length of Qₘ bits as discussed above with regard to multiplexer 125. After interleaving N such input signals, the bit-combined output from combiner 421 will also be arranged from a zeroth bit-combined word to a last bit-combined word (word N*H′−1). However, the zeroth to the (N−1) bit-combined output words correspond to the zeroth words in the N multiplexed data and CQI information signals being bit-combined. Similarly, the N to the (2*N−1) bit-combined output words correspond to the first words in the N multiplexed data and CQI information signals being bit-combined, and so on such that the (N−1)*(H′−1) to the N*(H′−1) bit-combined output words correspond to the last words in each of the N multiplexed data and CQI information input signals being bit-combined. The resulting bit-combined multiplexed data and CQI information output signal may thus be designated as [g′₀, g′₁, g′₂, g′₃, . . . g′_{NH′-1].}

Bit combiners 422 and 423 perform analogous bit combinations on the N channel-coded RI input signals and the N channel-coded HARQ-ACK input streams for the N transport blocks being interleaved. Bit combiner 422 thus produces a bit-combined RI output signal designated as [q′₀^{RI}, q′₁^{RI}, q′₂^{RI}, . . . , q_{NQ′}_{_{RI}}₋₁^{RI}] whereas bit combiner 423 produces a bit-combined HARQ-ACK output signal designated as [q′₀^{ACK}, q′₁^{ACK}, q′₂^{ACK}, . . . , q′_{NQ′}_{_{ACK}}₋₁^{ACK}].

The second stage for CA channel interleaver 420 is a channel interleaver 425 that interleaves the three bit-combined output signals produced in the bit-combining first stage. The number of modulation symbols in each subframe is given by H″=N (H′+Q′_{RI}). Channel interleaver 425 is configured to derive its output bit sequence as follows: Interleaver 425 writes to an output matrix that may be stored in a memory or buffer as analogously described above with regard to conventional LTE processing. The number of columns for this output matrix is given by Cₘᵤₓ=N_{symb}^{PUSCH}. The columns of the matrix are numbered 0, 1, 2, . . . , Cₘᵤₓ−1 from left to right as also previously discussed. However, the number of rows is given by Rₘᵤₓ=(H″·Qₘ)/Cₘᵤₓ, which is N times of the number of rows in LTE UL. Each continuous block of Rₘᵤₓ/N rows in the output matrix may be considered to form a sub-matrix that corresponds to one CC. There are thus N sub-matrices in the output matrix corresponding to the N CCs.

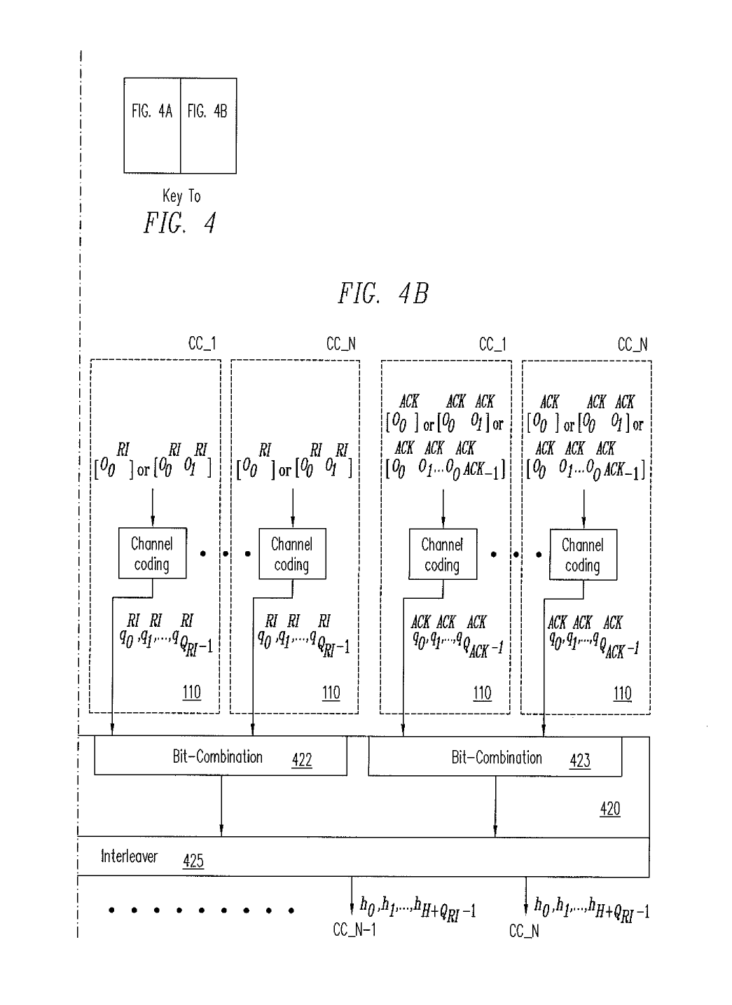

FIG. 5 illustrates the interleaving process performed by interleaver 425. In an initial step 500, interleaver 425 determines the number N of component carriers being aggregated so that the appropriate bit combination may be performed in a step 505. Interleaver 425 may then identify what type of bit-combined signal is currently being processed in a step 510. There are then 3 paths to take depending upon whether step 510 identifies data/CQI information, RI information, or HARQ-ACK information. If RI information is included in this subframe, then the RI information is written first to the output matrix. Thus, a step 515 delays the processing of data/CQI information until the RI information has been interleaved into the output matrix.

RI information is processed in a step 520 by being segmented into N equal subsequences. For example, if the input to step 510 is considered to form an input signal [a₁, a₂, . . . , aₙ], then the output from step 520 forms the N subsequences [a₁, a₂, . . . , a_{n/N}], . . . , [a_{n-n/N+1}, a_{n-n/N+2}, . . . , aₙ]. Each subsequence corresponds to a CC transport block. Each subsequence is interleaved into the corresponding carrier component sub-matrix in a step 525 following the way discussed above with regard to step 210 of FIG. 2. However, whereas step 210 of FIG. 2 is interleaving the RI information into the entire output matrix, step 525 is merely interleaving into the corresponding sub-matrix.

With RI information interleaving completed, the data/CQI information may interleaved in a step 530 by writing the input vector sequence, for k=0, 1, . . . , NH′−1 into the (Rₘᵤₓ×Cₘᵤₓ) output matrix by sets of Qₘ rows starting with the vector y₀ in column 0 and rows 0 to (Qₘ−1) and skipping the matrix entries that are already occupied by RI information as:

$$[ \begin{matrix}{\underline{y}}_{0} & {\underline{y}}_{1} & {\underline{y}}_{2} & … & {\underline{y}}_{{C}_{mux} - 1} \\ {\underline{y}}_{{C}_{mux}} & {\underline{y}}_{{C}_{mux} + 1} & {\underline{y}}_{{C}_{mux} + 2} & … & {\underline{y}}_{2 {C}_{mux} - 1} \\ ⋮ & ⋮ & ⋮ & ⋱ & ⋮ \\ {\underline{y}}_{( {R}_{mux}^{′} - 1 ) \times {C}_{mux}} & {\underline{y}}_{( {R}_{mux}^{′} - 1 ) \times {C}_{mux} + 1} & {\underline{y}}_{( {R}_{mux}^{′} - 1 ) \times {C}_{mux} + 2} & … & {\underline{y}}_{( {R}_{mux}^{′} \times {C}_{mux} - 1 )}\end{matrix} ]$$

where R′ₘᵤₓ=Rₘᵤₓ/Qₘᵤₓ.

The HARQ-ACK information is written into the output matrix only after the RI information and the data/CQI information has been processed. Thus, a step 535 delays the interleaving of the HARQ-ACK information accordingly. Once step 535 determines that the RI information and the data/CQI information has been processed, the HARQ-ACK information is segmented in a step 540 in same way as discussed with regard to step 525. Each resulting subsequence corresponds to a carrier component and is interleaved in a step 545 into the corresponding CC sub-matrix as discussed with regard to step 225 of FIG. 2. However, whereas step 225 discusses interleaving into an entire output matrix, the output matrix for step 545 is instead the corresponding sub-matrix.

With the output matrix thus completed, the component carrier data may be read from the corresponding sub-matrix column-by-column in a final step 550. The result would be N output code words for the N component carriers. It can readily be seen that if N=1, the CA channel interleaver 420 performs exactly the same as the conventional 120 channel interleaver discussed with regard to FIG. 1. Therefore, backward compatibility with LTE UL is advantageously achieved. Carrier aggregation for the shared downlink channel will now be discussed.

### Downlink Carrier Aggregation Channel Interleaver

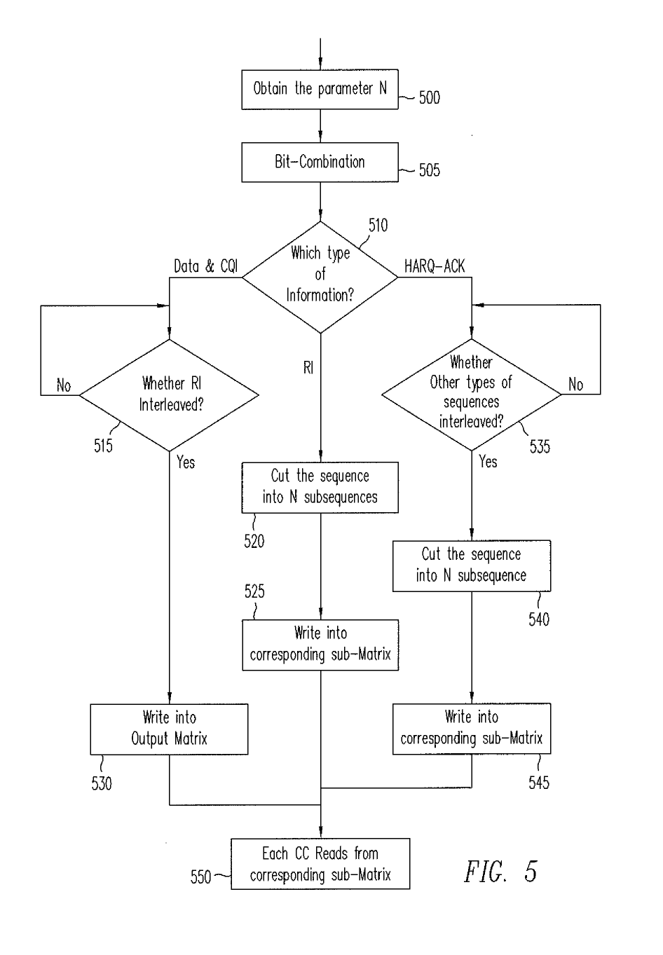

As shown in FIG. 6, a downlink carrier aggregation channel interleaver 620 includes a bit combining stage and an interleaving stage as analogously discussed above with regard to the uplink shared channel. A bit combiner 630 bit combines the channel-coded outputs from each of the N component carrier channels. The channel coding within each component carrier channel occurs as discussed with regard to FIG. 3. Thus each component carrier channel CC_{—}1 through CC_N includes already-described modules 300, 305, 310, 315, and 321. Bit combination stage 630 thus bit combines N input channel-coded transport blocks in the same fashion as discussed with regard to combiners 421 through 423 of FIG. 4.

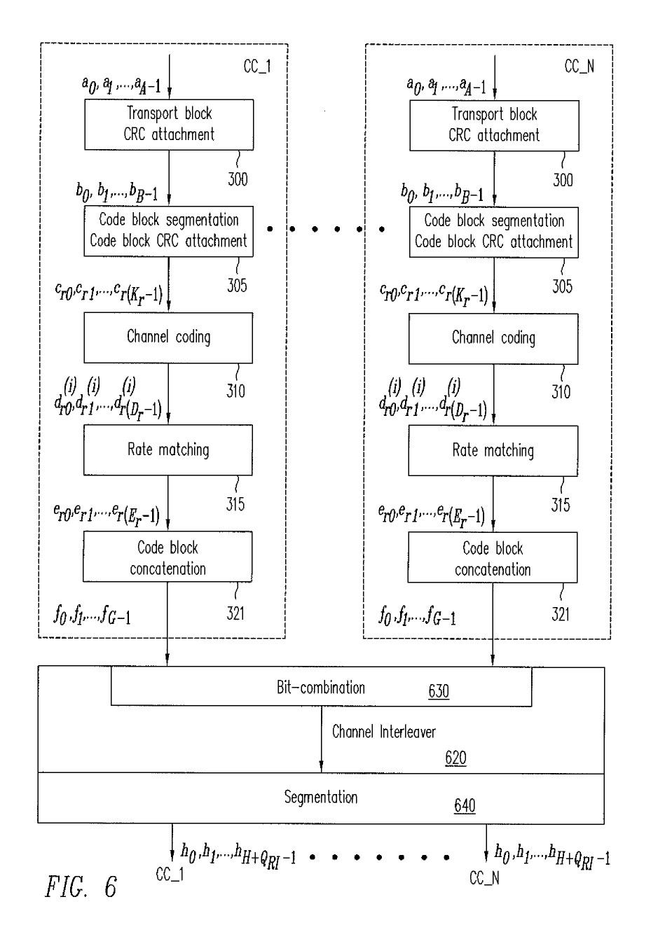

The resulting bit-combined output from combiner 630 is received by a carrier aggregation channel interleaver 640. FIG. 7 illustrates the channel interleaving process performed by interleaver 640. In an initial step 700, the number N of component carriers being aggregated is determined. Since there is no channel interleaving in a conventional LTE shared downlink channel, interleaver 640 and bit combiner 630 check whether N equals one in a step 705. If N equals one (no carrier aggregation), the remaining steps in FIG. 7 are skipped. If N is greater than one, bit combiner 630 performs a bit combination step 710 as discussed analogously with regard to step 505 of FIG. 5. The data can then be interleaved into an output matrix within an associated memory by interleaver 640 in a step 715 as follows: Assign Cₘᵤₓ=N_{symb}^{PUSCH} to be the number of columns of the matrix, where Cₘᵤₓ is defined as discussed above. The columns of the output matrix are numbered 0, 1, 2, . . . , Cₘᵤₓ−1 from left to right. The number of modulation symbols in each subframe is given by H′=N*G, where G is as defined as discussed above with regard to module 321. The number of rows of the matrix is given by Rₘᵤₓ, where Rₘᵤₓ=H′Qₘ/Cₘᵤₓ, and we also have R′ₘᵤₓ=Rₘᵤₓ/Qₘ. Each continuous set of Rₘᵤₓ/N rows of the output matrix maybe considered to form a sub-matrix. There are thus N sub-matrices corresponding to the N component carriers. Interleaver 640 writes the input vector sequence, for k=0, 1, . . . , NH′−1 into the (Rₘᵤₓ×Cₘᵤₓ) output matrix by sets of Qₘ, rows starting with the vector y₀ in column 0 and rows 0 to (Qₘ−1) and skipping the matrix entries that are already occupied by RI information as:

$$[ \begin{matrix}{\underline{y}}_{0} & {\underline{y}}_{1} & {\underline{y}}_{2} & … & {\underline{y}}_{{C}_{mux} - 1} \\ {\underline{y}}_{{C}_{mux}} & {\underline{y}}_{{C}_{mux} + 1} & {\underline{y}}_{{C}_{mux} + 2} & … & {\underline{y}}_{2 {C}_{mux} - 1} \\ ⋮ & ⋮ & ⋮ & ⋱ & ⋮ \\ {\underline{y}}_{( {R}_{mux}^{′} - 1 ) \times {C}_{mux}} & {\underline{y}}_{( {R}_{mux}^{′} - 1 ) \times {C}_{mux} + 1} & {\underline{y}}_{( {R}_{mux}^{′} - 1 ) \times {C}_{mux} + 2} & … & {\underline{y}}_{( {R}_{mux}^{′} \times {C}_{mux} - 1 )}\end{matrix} ]$$

Each carrier component is read from its sub-matrix column-by-column in a step 720 to complete the downlink processing. Each sub-matrix thus corresponds to a component carrier code word. One can observe from FIG. 7 that if N=1, the proposed channel interleaver will be skipped, thus maintaining compatibility with LTE DL.

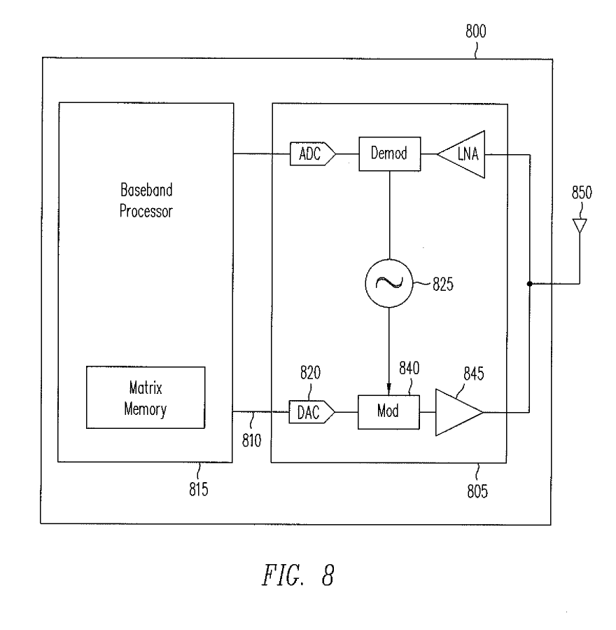

The above carrier aggregation process may be entirely implemented at baseband and is thus readily implemented in a baseband processor. FIG. 8 illustrates a generic radio architecture that may represent either a base station (for the downlink) or a user equipment (for the uplink). Radio 800 includes a radio frequency integrated circuit (RFIC) 805 that receives a baseband signal 810 from a baseband processor 815. Baseband signal 810 could be the baseband uplink or downlink signal depending upon whether radio 800 is implementing a user equipment or a base station, respectively. A DAC 820 converts signal 810 into analog form so that it may modulate an RF carrier (or carriers) produced by an oscillator 820 within a modulator 840. A power amplifier 845 amplifies the resulting modulated RF signal so that it may be transmitted by an antenna (or antennas) 850. A receive RF path is also shown within RFIC 805 although this path is not important for the uplink and downlink processing disclosed herein and will thus not be discussed in further detail.

Baseband processor 815 may be programmable such that it implements the downlink or uplink modules discussed above using software implemented on a microprocessor or through programmed logic resources within an FPGA. Alternatively, baseband processor 815 may be a dedicated ASIC. Regardless of how the baseband processing is implemented, it will advantageously interleave the downlink or uplink shared channel across the component carriers to exploit frequency diversity as discussed herein.

Embodiments described above illustrate but do not limit the disclosure. It should also be understood that numerous modifications and variations are possible in accordance with the principles of the present disclosure. For example, although the frequency diversity exploitation discussed above was regard to an LTE enhancement, it will be appreciated that the same technique can be readily applied to other high speed wireless protocols such as WiMax. Accordingly, the scope of the disclosure is defined only by the following claims.

We claim:

1. A method, comprising:
providing a plurality of transport blocks, each transport block corresponding to a component carrier (CC) such that a plurality of component carriers corresponds to the plurality of transport blocks;
in a baseband processor, channel coding a data portion of each transport block into a corresponding channel-coded input data signal;
in the baseband processor, bit-combining the channel-coded input data signals into a bit-combined data signal; and
in the baseband processor, interleaving the bit-combined data signal to produce an interleaved plurality of code words corresponding to the plurality of component carriers.

2. The method of claim 1, wherein the transport blocks are uplink shared channel transport blocks.

3. The method of claim 2, further comprising:
in the baseband processor, channel coding a control quality information (CQI) portion of each transport block into a corresponding channel-coded CQI signal; and
in the baseband processor, multiplexing each channel-coded input data signal with a corresponding one of the channel-coded CQI signals to produce a plurality of multiplexed data signals, wherein bit-combining the channel-coded data signals comprises bit-combining the multiplexed data signals.

4. The method of claim 3, further comprising:
channel coding a rank indication (RI) portion of each transport block into a corresponding channel-coded RI signal;
channel coding a HARQ-ACK portion of each transport block into a corresponding channel-coded HARQ-ACK signal;
bit-combining the channel-coded RI signals into a bit-combined RI signal;
bit-combining the channel-coded HARQ-ACK signals into a bit-combined HARQ-ACK signal, wherein interleaving the bit-combined data signal comprises interleaving the bit-combined data signal with the bit-combined RI and HARQ-ACK signals.

5. The method of claim 4, wherein interleaving the bit-combined RI signal comprises separating the bit-combined RI signal into a plurality of RI subsequences corresponding to the plurality of component carriers, and interleaving each RI subsequence.

6. The method of claim 4, wherein interleaving the bit-combined HARQ-ACK signal comprises separating the bit-combined HARQ-ACK signal into a plurality of HARQ-ACK subsequences corresponding to the plurality of component carriers, and interleaving each HARQ-ACK subsequence.

7. The method of claim 1, wherein the transport blocks are downlink shared channel transport blocks.

8. A downlink method, comprising
determining whether a plurality of component carriers are being interleaved;
if a plurality of component carriers are being interleaved, bit-combining a plurality of channel-coded data signals to form a bit-combined data signal;
writing the bit-combined data signal into an interleaver matrix stored within a memory, wherein the interleaver matrix is arranged into a plurality of sub-matrices corresponding to the plurality of component carriers;
reading from each sub-matrix to retrieve a corresponding output code word; and
modulating each component carrier according to the corresponding output code word.

9. The downlink method of claim 8, wherein Qₘ represents a modulation order, and wherein the bit-combined data signal is written into the interleaver matrix a set of Qₘ rows at a time.

10. A wireless device, comprising:
a memory;
a baseband processor configured to channel code a plurality transport blocks data portions into a corresponding plurality of channel-coded data signals, bit-combine the channel-coded data signals into a bit-combined data signal, write the bit-combined data signal into an interleaver matrix stored within the memory, and to read from the interleaver matrix to produce an interleaved plurality of code words; and
a radio-frequency integrated circuit (RFIC) configured to modulate an RF carrier signal according to the interleaved plurality of code words.

11. The wireless device of claim 10, wherein the transport blocks are uplink shared channel transport blocks.

12. The wireless device of claim 11, wherein the baseband processor is further configured to channel code a plurality of channel quality information (CQI) control signal transport block portions into a corresponding channel-coded CQI data signal, and to multiplex each channel-coded data signal with a corresponding one of the channel-coded CQI data signals to produce a plurality of multiplexed data signals, and wherein the baseband processor is configured to bit-combine the channel-coded data signals by bit-combining the multiplexed data signals.

13. The wireless device of claim 12, wherein the baseband processor is further configured to channel code a plurality of rank indication (RI) and hybrid repeat request acknowledgment (HARQ-ACK) transport block portions corresponding to provide channel-coded RI signals and channel-coded HARQ-ACK signals, and to bit-combine the channel-coded RI signals into a bit-combined RI signal, and to bit-combine the channel-coded HARQ-ACK signals into a bit-combined HARQ-ACK signal, and wherein the baseband processor is configured to interleave the bit-combined data signals with the bit-combined RI and HARQ-ACK signals.

14. The wireless device of claim 13, wherein the baseband processor is configured to interleave the bit-combined RI signal by separating the bit-combined RI signal into a plurality of RI subsequences corresponding to the plurality of component carriers, and to interleave each RI subsequence.

15. The wireless device of claim 14, wherein the baseband processor is configured to interleave the bit-combined HARQ-ACK signal by separating the bit-combined HARQ-ACK signal into a plurality of HARQ-ACK subsequences corresponding to the plurality of component carriers, and to interleave each HARQ-ACK subsequence.

16. The wireless device of claim 15, wherein the wireless device comprises an LTE-Advanced user equipment.

17. The wireless device of claim 10, wherein the transport blocks are downlink shared channel transport blocks.

18. The wireless device of claim 17, wherein the wireless device is an LTE-Advanced base station.

19. The wireless device of claim 10, wherein each channel-coded data signal is arranged from a first channel-coded digital word to a last channel-coded digital word, and wherein the baseband processor is configured to bit-combine the channel-coded data signals such that the bit-combined data signal is arranged from a first bit-combined digital word to a last bit-combined digital word corresponding to the digital words in each of the channel-coded data signals, wherein each bit-combined digital word is a combination of the corresponding channel-coded digital words.

20. The wireless device of claim 10, wherein the baseband processor is further configured to read from the interleaver matrix row-by-row to produce the interleaved plurality of code words.
